(19) United States
(12) Patent Application Publication
(10) Pub. No.: US 2011/0179270 A1
(43) Pub. Date: Jul. 21, 2011

(54) Data Retrieval System

(75) Inventors: Hitesh Tewari, Dublin (IE); Desmond Ennis, Dublin (IE)

(73) Assignee: The Provost, Fellows and Scholars of the College of the Holy and Undivided Trinity of Queen Elizab, Dublin (IE)

(21) Appl. No.: 12/690,465

(22) Filed: Jan. 20, 2010

(51) Int. Cl. G06F 17/30; G06F 15/16; H04L 29/06

(52) U.S. Cl. 713/165; 726/5; 707/621; 707/705; 707/E17.005; 707/E17.01; 707/E17.107

(57) ABSTRACT

A method is disclosed for retrieving data from a wireless device over a wireless network for submission to an application provided on a user terminal. The method includes the steps of detecting for a wireless device having a data file stored thereon when the application is running on the user terminal; and if a data file is detected, in response to an attempt by a user at the user terminal to access a document accessible through the application where data is required to complete a request for access to the document, determining whether the required data exists on the data file; retrieving the required data from the data file and submitting the retrieved data to the application for generation of an access request.

### BACKGROUND

The present invention is related to an improved method and apparatus for retrieving data from a wireless device via a computer application over a wireless network, and in particular retrieving data for use online via an internet browser application.

Most users of the World Wide Web maintain various authentication-enabled accounts, profiles and identities to access websites and on-line services they use on a regular basis. Typically, each of these websites and services operate a bespoke authentication scheme that users must embrace. Authentication credentials generally consist of a username and a password, but other arrangements are also known.

It will be appreciated that as the number of websites and service subscriptions increases, so does the number of bespoke authentication schemes. This leads to a situation where users have to remember numerous sets of authentication credentials, resulting in a tendency by some users to homogenize authentication details through selecting the same passwords for multiple sites. This is clearly an undesirable arrangement, because if the user credentials for one site are compromised, the corresponding authentication-enabled accounts on other sites are thereby also compromised. A second drawback to this arrangement is that this burden can give rise to weak password selection, as users would otherwise struggle to remember all the passwords they regularly use. Weak passwords clearly also result in a compromised authentication process.

It is therefore desirable to provide a system whereby once a user authenticates a single time, they are then granted access to all the websites for which they are authorized.

Some solutions to this problem allow all authentication credentials for a given user to be stored on a “keychain” locally on the user's computer. A “keychain” is an electronic mechanism that provides secure storage of authentication details such as usernames and passwords for later retrieval and use. It may also be used to provide secure storage for encryption/decryption keys used to encode data. When return visits are made to websites for which keychain entries exist, automated logon can be performed. The keychain however is only accessible from the terminal it is installed upon, and therefore if a user tries to access a website requiring authentication credentials stored on the keychain from another terminal, the keychain data will not be available and it becomes necessary for the user to manually input their authentication credentials once more.

Another solution with a similar drawback is a system whereby a website requiring authentication stores a cookie in the browser cache of a user's terminal once the user has authenticated during a first session. Upon return visits to this site, the cookie is used to verify the user, and automatic logon is performed. Not only is this solution sub-optimal because the cookies are stored on a single terminal (precluding automatic logon by the same user from other terminals), but when the browser cache is cleared, subsequent logins require manual input of credentials once again. Furthermore, this solution needs to be implemented by operators of all websites requiring authentication.

Proprietary solutions, also exist in an attempt to address the above problem, such as those provided by LastPass (lastpass.com) and CyberScrub (http://www.cyberscrub.com/). In these solutions, the primary keychain data source is the local computer. This source can be restored (when required) either from a third party server also connected to the internet, or from a Universal Serial Bus (USB) flash drive backup, with the drives needing to be physically connected to the terminals to provide this capability. In addition, some such solutions offer a mobile synchronization feature, which permits users to synchronize the keychain data on first local computer with the keychain data on a second local computer. In such a situation, multiple copies of the same keychain are in play at the same time, and for some operating systems, third party software (such as Apple's iTunes®) is required to facilitate synchronization between the multiple copies. These solutions are sub-optimal either because there is a dependency on the integrity and functionality of third party systems, or because it is necessary to acquire and then carry the additional hardware. It is inconvenient for users to be dependent on third party servers because these systems must be fully functional and contactable in order to facilitate multi-terminal access to their keychain data. The alternative presented by these systems is also inconvenient for users, because it is impractical to carry around a dedicated hardware device (such as a USB flash drive) in order to facilitate multi-terminal access to their keychain data. Furthermore, there is an added inconvenience on some operating systems, where additional third party software is required to implement the system. Finally, there is a distinct disadvantage to maintaining multiple copies of the keychain data locally on different machines, as at least some level of user intervention is required in order to keep each copy of the keychain data synchronized and up to date.

An alternative approach to solving the problem has been to require users to authenticate only once with a certified, centralized server, which in turn authenticates the user with the various websites to which they have provided authentication credentials. The drawback to such a system (exemplified by products such as Windows Live ID™), is that they require industry-wide adoption, and unless every authentication-enabled website and service that users wish to use implements such a scheme, a true single sign-on cannot be realized.

Similar problems exist for users who wish to share sensitive desktop documents or to store such documents online, but in a secure manner. With the growing popularity of cloud computing, it is becoming increasingly common for users to store documents on remote servers using services such as Google Docs™. In order to address security concerns relating to the transmission of sensitive documents via the Internet or concerns relating to the storage of potentially sensitive information with third parties, it may be desirable to encrypt such documents. Thus, every time a user wishes to work on such a document, it is first necessary to decrypt it, using the appropriate decryption key. Equally, once amendments are made to the document, it is necessary to re-encrypt it using the appropriate encryption key before once more transmitting it or saving it to a remote server. Encryption and/or decryption keys can often be unwieldy and difficult to remember. This thus presents a difficulty to users who wish to access their documents from a variety of terminals, as it is necessary for them to carry their encryption and/or decryption keys at all times to enable them to access and modify their documents from any location. While it is possible to carry these keys on a USB stick, this is impractical as it necessitates acquiring and carrying additional hardware everywhere. In addition, USB ports may not always be accessible on a terminal, or may be disabled, and there may be compatibility issues, depending on the age of the devices being used.

It is clear that there is a need for a secure single sign-on mechanism for all authentication-enabled websites that can be used at multiple terminals, without placing any requirement on the websites to adopt proprietary authentication or open identity schemes. In addition, it is also desirable to provide for a more convenient means of retaining sensitive data such as cryptographic keys that may be required on a regular basis in such a way that the sensitive data is not exposed to third parties.

It is an object of the invention to provide a single sign-on mechanism that allows a user access to multiple websites requiring user credential authentication. It is also an object of this invention to provide this mechanism in such a way that successful use of the mechanism by a single user is not restricted to a single computer. It is another object of the invention that implementation of the mechanism does not necessitate any modification of existing websites that require authentication. It is a further object of the invention to provide the mechanism in such a way that authentication credentials are stored securely. It is also an object of this invention to provide for a convenient, portable means of carrying encryption and/or decryption keys, such that they may be easily used in conjunction with any one of a number of computer terminals. It is an additional object of this invention to provide the mechanism in such a way that the processing speed of any device other than the one being used to access the website has a minimal impact on any of the aforementioned objectives.

### SUMMARY

One aspect of the invention is a method of retrieving data from a wireless device over a wireless network for submission to an application provided on a user terminal, the method comprising the steps of: detecting for a wireless device when the application is running on the user terminal; and if a wireless device is detected, in response to an attempt by a user at the user terminal to access a document accessible through the application where data is required to complete a request for access to the document, determining whether the required data exists on a data file stored on the wireless device; retrieving the required data from the data file; and submitting the retrieved data to the application for generation of an access request.

In another aspect, the method further comprises wherein the document is one of a website file type, a word processing application file type, a spreadsheet application file type, a document representation application file type, or a presentation application file type.

In a further aspect, the method further comprises wherein the application is an internet browser application.

Further to the above, an aspect of the invention further comprises wherein the internet browser application is further for performing the steps of the method.

In an aspect, the method further comprises wherein the application is an internet browser application having an associated plug-in for performing the steps of the method.

In another aspect, the method further comprises wherein the application is one of a word processing application, a spreadsheet application, a document representation application, or a presentation application.

In an additional aspect, the method further comprises the steps of: if the detected wireless device is in communication with the user terminal for the first time, the method further comprising the step of associating the detected wireless device with the user terminal by: requesting the user to provide the application with identification credentials unique to the wireless device; and requesting the user to confirm on the wireless device that the wireless device is to communicate with the user terminal.

Further to the above, in an additional aspect the method further comprising the steps of: if a plurality of wireless devices are detected, none of which have previously communicated with the user terminal, before requesting the user to associate a wireless device with the user terminal, requesting the user to select the desired wireless device from the plurality of wireless devices to associate with the user terminal.

In an additional aspect, the website further comprises the step of automatically generating the access request.

Further to where the application is an internet browser application, a further aspect of the invention comprises wherein the data comprises user authentication credentials for a website.

Further to where the wherein the application is one of a word processing application, a spreadsheet application, a document representation application, or a presentation application, a further aspect of the invention comprises wherein the data comprises a cryptographic key.

In an additional aspect of the invention, the method further comprises wherein the data file is encrypted, and also further comprises the step of decrypting at least the required data from the data file prior to submitting the data to the application.

In another aspect of the invention, the method further comprises the step of copying the detected data file from the wireless device to a storage on the user terminal; and wherein the data file from which the required data is retrieved corresponds to the data file stored on the user terminal.

Further to the above, a further aspect of the invention comprises the method further comprises wherein said data file is copied to the storage of said user terminal only once at least a portion of the data contained in the data file is required.

Further to the above, a further aspect of the invention comprises wherein only the required portion of said data file is copied to the storage of said user terminal.

In one aspect of the invention, the method further comprises wherein the wireless communication is via Bluetooth.

In an aspect of the invention, the method further comprises wherein if the required data does not exist on the data file, further comprising the step of requesting the user to submit the required data for the document to the application, and updating the existing data file with the required data.

Further to the above, another aspect of the invention comprises wherein the requesting and updating steps are only performed in the event that access to the document is secure.

Further to where the method additionally comprises the steps of requesting the user to submit the required data and updating the existing data file, an additional aspect of the invention comprises the method further comprising the step of receiving confirmation from the user that the existing data file is to be updated with the required data prior to performing the update.

Further to where the method additionally comprises the steps of requesting the user to submit the required data and updating the existing data file, an additional aspect of the invention comprises the method further comprising wherein the step of updating the existing data file with the required data comprises the steps of updating the stored copy of the data file on the user terminal; and transmitting the updated copy of the data file to the detected wireless device.

In one aspect of the invention, the method further comprises the step of deleting the stored copy of the data file on the user terminal once the application is no longer running on the user terminal.

Another aspect of the invention comprises a method of retrieving data from a wireless device over a wireless network for submission to a website accessible by a browser application provided on a user terminal, the method comprising the steps of: detecting for a wireless device when the browser application is running on the user terminal; and if a wireless device is detected, in response to an attempt by a user at the user terminal to access a website via the browser application where data required to complete a request for access to the website, determining whether the required data exists on a data file stored on the wireless device; retrieving the required data from the data file and submitting the retrieved data to the application for generation of the access request.

Yet another aspect of the invention comprises a method of retrieving data from a wireless device over a wireless network for encrypting or decrypting a document accessible via a document website through a browser application provided on a user terminal, the website adapted to communicate with a document server, the method comprising the steps of: detecting for a wireless device when the browser application is running on the user terminal; and if a wireless device is detected, in response to an attempt by a user at the user terminal to access or store a document at the document server through the document website: where data is required to access or store the document; determining whether the required data exists on a data file stored on the wireless device; retrieving the required data from the data file; and using the retrieved data to encrypt the document for storage or decrypt the document for access.

Further to the above, in one aspect of the invention, the method further comprises wherein if the required data does not exist on the data file and if it is desired to encrypt the document for storage, the method also further comprises the steps of: generating the cryptographic key automatically; encrypting the document using the cryptographic key prior to storage; and updating the data file with the cryptographic key data.

Further to the above, in one aspect of the invention, the method further comprises the step of transmitting the cryptographic key to third parties.

Further to the above, in one aspect of the invention, the method further comprises wherein the cryptographic key is transmitted via SMS messaging.

Another aspect of the invention comprises an apparatus for retrieving data from a wireless device over a wireless network for submission to an application provided on a user terminal, the apparatus comprising: logic configured to detect for a wireless device when the application is running on the user terminal; and if a wireless device is detected, in response to an attempt by a user at the user terminal to access a document accessible through the application where data is required to complete a request for access to the document, logic configured to determine whether the required data exists on a data file stored on the wireless device; logic configured to retrieve the required data from the data file and logic configured to submit the retrieved data to the application for generation of an access request.

Yet another aspect of the invention comprises a computer program media embodying a program of instructions executable on a computer to perform a method for retrieving data from a wireless device over a wireless network for submission to an application provided on a user terminal, the method comprising the steps of: detecting for a wireless device when the application is running on the user terminal; and if a wireless device is detected, in response to an attempt by a user at the user terminal to access a document accessible through the application where data is required to complete a request for access to the document, determining whether the required data exists on a data file stored on the wireless device; retrieving the required data from the data file and submitting the retrieved data to the application for generation of an access request.

### BRIEF DESCRIPTION OF THE DRAWINGS

FIG. 1 is a high-level schematic of the relationship between various components involved of the present invention;

FIG. 2 is a flowchart illustrating the steps of the once per-session initialization process, and the pairing/association process that takes place once per browsing computer/wireless device pair;

FIG. 3 is a flowchart illustrating the steps of the method of one embodiment of the present invention for retrieving a user's credentials to allow access to an authentication enabled website;

FIG. 4 is a flowchart illustrating a method of decrypting a requested online document in accordance with the present invention;

FIG. 5 is a flowchart illustrating a method of encrypting a document being submitted to an online service incorporating the ability to share the cryptographic key with other users;

FIG. 6 is a flowchart illustrating a method of encrypting/decrypting desktop documents incorporating the ability to share the cryptographic key with other users; and

FIG. 7 is a flowchart illustrating the method by which a user's keychain can be remotely updated by another user via a SMS text message.

### DETAILED DESCRIPTION

In one embodiment of the present invention, a single sign-on mechanism is provided wherein a user's authentication credentials for a variety of websites are encrypted and stored on a keychain, which is located on a personal wireless communication device belonging to the user, such as a cellular phone or a PDA. As owners of personal wireless communication devices (hereafter referred to as “wireless devices”) are inclined to keep the device with them at all times, these devices make for suitable portable keychain storage means. When the user of a wireless device storing such a keychain attempts to access the world wide web via a computer with some form of wireless communication capability (hereafter referred to as the “browsing computer”), it is possible to retrieve authentication credentials from the keychain. This is done via wireless communication between the browsing computer and the wireless device. It should be apparent that the means of wireless communication may be any one of a variety of wireless communication means, including but not limited to, Bluetooth®, InfraRed, WiFi or WiFi Direct.

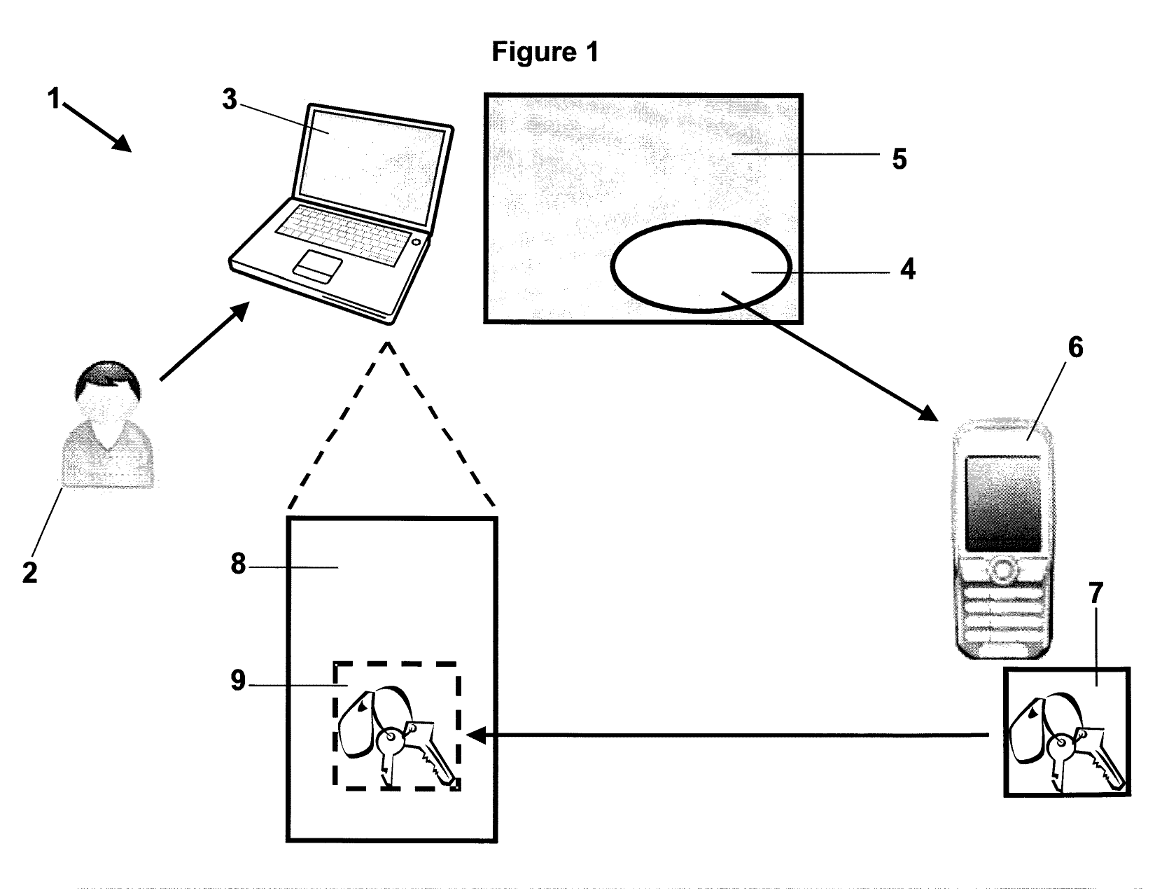

A system (1), showing the main components of one embodiment of the present invention is depicted in FIG. 1. A browsing computer (3) is provided on which a software extension or “plug-in” (4) is installed. The plug-in works in conjunction with an internet browser application (5) on said computer. This plug-in facilitates wireless communication between the browsing computer and a wireless device (6) of a user (2) having stored thereon a keychain (7), allowing authentication details to be retrieved from the wireless device when appropriate, and also allowing an automatic logon to be performed. Accordingly, in one embodiment, a user (2) attempting to access the world wide web using a browser computer (3) upon which the plug-in (4) has been installed, triggers plug-in (4) to make a copy (9) of the keychain (7) from the wireless device and to store it in the memory (8) of the browsing computer. It will be understood by the skilled person that while this memory is typically the temporary memory of the browsing computer, any form of computer memory may be fit for this purpose. In the event a request is then submitted to retrieve a website requiring authentication details stored on the keychain, it is then possible for the plug-in (4) to perform an automatic logon to this website. The plug-in (4) does this by retrieving the relevant credentials from the copy of the keychain (9) as stored in the browsing computer's memory (8), and populating the corresponding authentication credential entry fields on the website. In one embodiment, the plug-in then automatically submits the logon request to the website.

It will be appreciated by the skilled user that the above is not the only possible configuration, and many others are possible. For instance, in an alternative arrangement, the plug-in (4) may be configured to copy the keychain (7) to memory (8) only in the event that the user is attempting to access a website requiring authentication details stored on the keychain. As a further alternative, the plug-in (4) may be configured only to copy the credentials necessary from the keychain (7) held on the wireless device for the particular website the user is trying to access.

It is preferable for the keychain data to be securely stored on the wireless device. One manner in which this may be done is by encrypting the keychain data itself. Accordingly, when the keychain is (or parts of the keychain are) copied in any way to the memory of the browsing computer, these copies will also be in encrypted form. It will be understood that this data may be encrypted in many ways. In one embodiment, the keychain data is encrypted using a master password-based cryptographic algorithm where the user is responsible for remembering the master password. One such algorithm is the Advanced Encryption Standard (AES) cryptographic algorithm, wherein the master password is used in a once-per-browser-session cryptographic key generation mechanism. It will be appreciated that other arrangements could be made to store the encryption key. For instance, an encryption key could be stored locally on the browsing computer or on a third-party server accessible over the internet.

When keychain data is secured, then it is necessary to comply with these security requirements in order to unsecure the keychain data and make it available for use. In an embodiment of the present invention wherein the keychain is encrypted with a master password-based cryptographic algorithm and the entire keychain is copied to the browsing computer as described in relation to FIG. 1, it is possible to prompt the user for the master password as soon as the keychain is copied. The decryption key is generated from this master password and retained locally for the duration of the browsing session. In the event that specific credentials are then needed when a website is visited, the necessary portions of the local copy of the encrypted keychain (i.e. the copy stored on the browsing computer) are then in turn copied, and these copied keychain portions can then be decrypted using the decryption key.

As an alternative embodiment, the local copy of the keychain may be entirely decrypted upon receipt of the decryption key and retained in the memory for use when required.

Once the logon is completed, the decrypted keychain portions may be immediately deleted. In a preferred embodiment, at the end of the browsing session (i.e. when the browsing application is closed), any outstanding data relating to the keychain is deleted (e.g. any secured or unsecured copies of the keychain or portions thereof, or any data relating to the securing of the keychain such as encryption keys etc). It will be further understood by the person skilled in the art that the specifics of such security compliance will be dependent upon the nature of the security methods utilized. Further still, there may be a variety of ways in which compliance with a particular security method may be achieved.

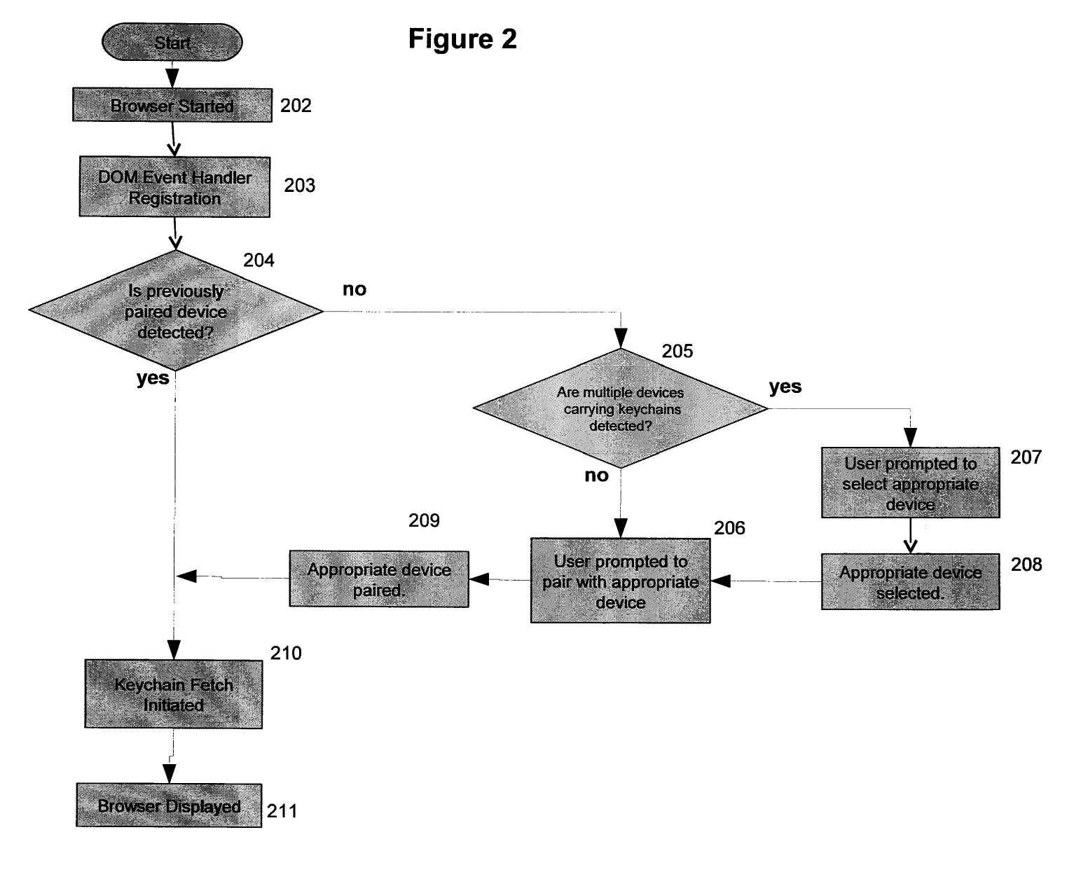

A preferred method of retrieving the keychain data from a wireless device will now be discussed with reference to FIG. 2 (herein referred to as the “initialization” process). At the beginning (202) of every world wide web browsing session on the browsing computer, the browser application and associated plug-in are started. As the browser application and the plug-in begin to run, the plug-in registers (203) a number of Document Object Model (DOM) Event Handlers. These DOM Event Handlers allow the plug-in to interact with the websites being browsed, by detecting websites that require authentication credentials and by performing automatic logons where appropriate. The plug-in then checks (204) to see whether a wireless device previously associated with the browsing computer is within range. This association process will be referred to from hereon in as the “pairing” process and will be discussed further below. In the event that no such previously paired device is detected, the plug-in searches (205) for all wireless devices within range. If only a single device is present, the plug-in prompts (206) the user to complete the wireless device/browsing computer pairing operation. Where more than one wireless device is detected, the plug-in may prompt (207) the user to select the relevant device from a list of detected devices. Once the relevant device has been selected (208), the user may then be prompted (206) to complete the wireless device/browsing computer pairing operation. This pairing process may be carried out in a number of ways. In one embodiment, the user is required to uniquely identify the wireless device they wish to pair with the browsing computer, by providing the plug-in with the device's unique International Mobile Equipment Identity (IMEI) number. It may also be desirable for the user to respond to a prompt on the wireless device as well, confirming that it is their wish to pair the wireless device with the browsing computer.

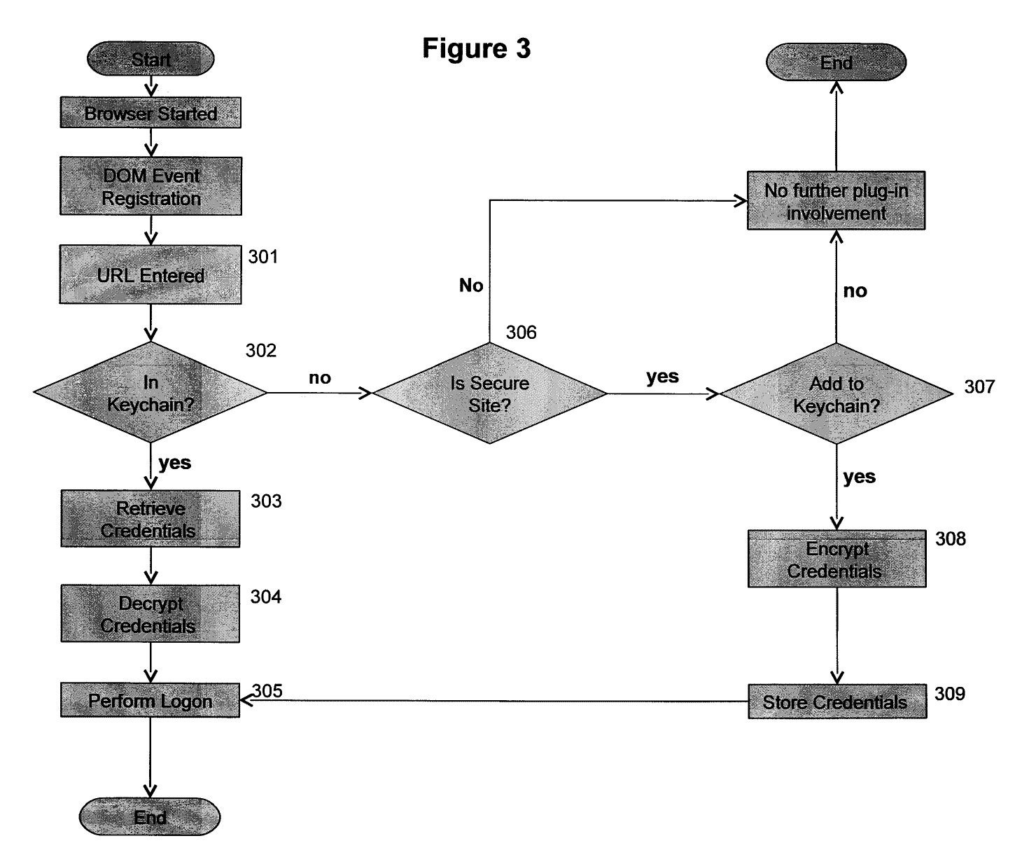

Once a paired device is detected the keychain fetch operation (210) may then be performed. The keychain fetch operation can be performed in a variety of ways, depending on the nature of the wireless communication between the browsing computer and the wireless device and in some instances also depending on the nature of the security measures—if any—used to secure the keychain data, as previously described. In one embodiment, the keychain fetch operation may consist of a simple FTP “get” operation. It may be that the wireless device paired with the browsing computer does not have a keychain stored thereon. In such circumstances, the plug-in may effectively regard this device as carrying a keychain with no entries, and may treat it accordingly. If, during the browsing session, the user seeks to add credentials to this “empty keychain” (as discussed further with respect to FIG. 3, below), a keychain data file is generated locally on the browsing computer and the plug-in then proceeds to add the new data as normal.

Once the keychain fetch operation (210) is complete, no further communication between the browsing computer and the wireless device is required for that browsing session. It will be appreciated that in this arrangement, the majority of the necessary processing is performed upon startup of the browsing session, thus ensuring that the dynamic detection and population of authentication credential fields on websites proceeds quickly and efficiently. The keychain fetch operation may proceed in parallel to the start-up of the browser and as a result the browser may be displayed (211) to the user before the fetch operation has been completed. Where no wireless devices are detected, the browsing session may proceed without any further involvement from the plug-in. Where no wireless device is detected upon browser startup, the plug-in periodically seeks to test that at least one wireless device is within communications range. However, if a device is detected to have subsequently come into range, the keychain fetch operation is then performed as already described.

As previously mentioned, the wireless communication between the browsing computer and the wireless device may be effected in a variety of ways. In one embodiment, the Bluetooth Generic Object Exchange Protocol is utilized to carry out this communication.

A typical implementation of an embodiment of the method of the invention for retrieving a user's credentials to allow access to an authentication-enabled website will now be discussed with reference to FIG. 3. Once initialization has been performed, a user may attempt to access a webpage on the world wide web by entering (301) a Universal Resource Locator (URL) in the browser application. Doing so prompts the plug-in to check (302) whether that URL exists in the keychain.

This checking is performed by one of the registered DOM Event Handlers. In the event said website does have a corresponding entry in the copied version of the keychain as stored in temporary memory, the plug-in retrieves said credentials (303). Where the credentials are encrypted, the plug-in also decrypts them (304) as previously described. Once the relevant credentials have been decrypted (if necessary), the plug-in may populate the corresponding authentication credential entry fields on the website. In one embodiment, the plug-in also automatically submits (305) the logon request to the website. Alternatively, the user may manually submit the details once the authentication credential entry fields have been populated. Once this submission has been made, the decrypted keychain entry is discarded (not shown). It will be appreciated that in at least one embodiment of the present invention, the user will be able to access webpages via the browser application before the initialization has been completed. However, due to the fact that the initialization is not complete, they will be able only to access credential-requiring websites by manually entering username/password combinations. Use of credentials in the keychain will only be possible once initialization is completed. It will also only be possible to add new details to the keychain once initialization is completed, but such additions may be queued in the browser for addition to the keychain once initialization is complete.

If a website requiring authentication credentials is being accessed that does not have a corresponding entry in the keychain, or if a keychain does not yet exist on the wireless device, it is desirable the user is presented with the option of entering said details onto the keychain. In this event, the plug-in may first assess whether said site is secure (306). It will be appreciated that it may be desirable to perform such an assessment for all websites accessed, and thus, it may alternatively be performed at any stage prior to this point. Typically, the assessment of whether or not a website is secure will be based on a digital certificate, but it will be understood that other means of security assessment may be equally suitable. If said website is considered secure, the user enters their authentication credentials as normal, but is then prompted (307) by the plug-in as to whether they wish to add these credentials to the keychain on the wireless device. This is done by the plug-in detecting that a user is about to submit new website credentials by checking for the presence of an authentication challenge on said website. The detection of an authentication challenge is performed by a DOM Event Handler and may be performed in a variety of ways, such as by detecting a password field on the website or by detecting the submission of a username and/or password. The user may be prompted (307) either before or after said credentials have been submitted, as to whether they wish to add the credentials (309) to the keychain. If the user chooses to add the credentials, they are first encrypted (308) if necessary and then stored (309) on the wireless device, after which the credentials can be manually or automatically submitted to the website in the form of a logon request. In the event the user chooses not to add the credentials to the keychain on the wireless device, the logon process proceeds without any further involvement from the plug-in. Where the security assessment (306) determines that the site being accessed is not secure, the logon process also in this case proceeds without any further involvement from the plug-in.

Where the keychain is encrypted, and the entire keychain is copied to the temporary memory of the browsing computer at the beginning of a browsing session as described in FIG. 2, step 308 further involves the steps of first encrypting the new keychain entry using the encryption key provided and then adding this encrypted entry to the encrypted copy of the keychain as stored on the browsing computer. This updated copy of the keychain is then sent back to the wireless device where it replaces the original keychain file stored thereon. This may be done simply by overwriting the original file, or alternatively, may comprise separate operations deleting the original keychain file and then saving the updated copy in its place. It will be appreciated that the addition of new entries to the keychain may be performed in a variety of ways, and the process may depend on the configuration of the embodiment of the invention in question.

It will also be understood that the operation to transfer the data to the wireless device can be performed in a variety of ways and may depend on the mode of wireless communication selected and/or the manner in which the keychain data is secured. In one embodiment, the updated keychain data may be transferred by way of a simple FTP “put” operation.

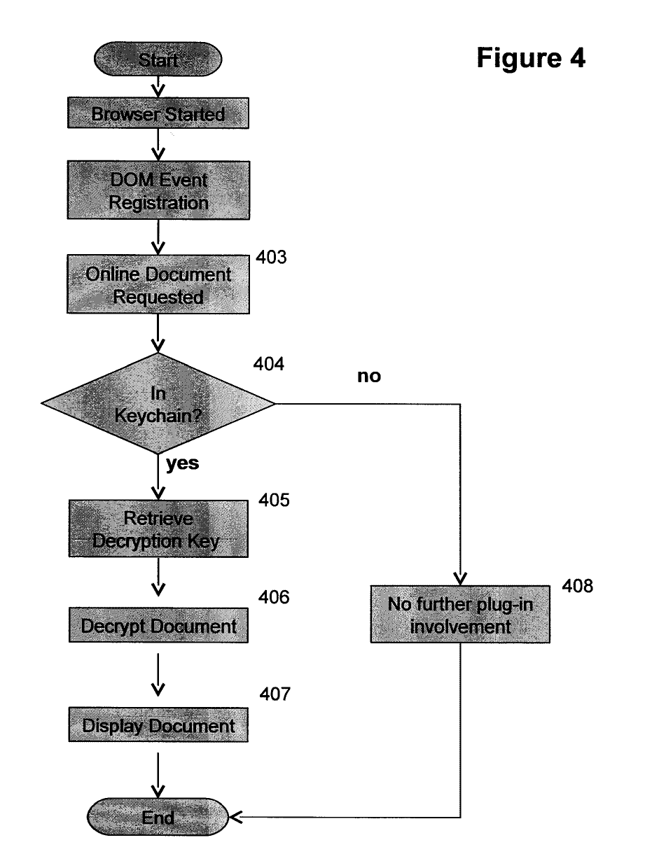

The invention can also be used to retrieve encrypted documents, where the keychain stores the decryption key. The steps involved when the invention as used to retrieve encrypted documents stored with a third party will now be described with respect to FIG. 4. Once initialization has been performed, a user of a browsing application may request (403) an online document from a third party that provides an online document storage/retrieval service, such as GoogleDocs®. The plug-in may first check whether a keychain entry exists for the decryption key associated with the requested document's unique identifier (404). It will be appreciated that the document may obtain its unique identifier in a number of different ways, for instance, by way of the unique server website URL corresponding to the document In the event an entry exists, this entry may be copied and decrypted if necessary, thereby retrieving the decryption key for said document. A DOM Event Handler may then decrypt (406) and display (407) the document for use by the user. There are a number of ways that the DOM Event Handler may be triggered, for instance as a response to an attempt to load the encrypted document. Where no keychain entry is found to exist for the document in question, the plug-in may cease to participate (408) in the document retrieval process.

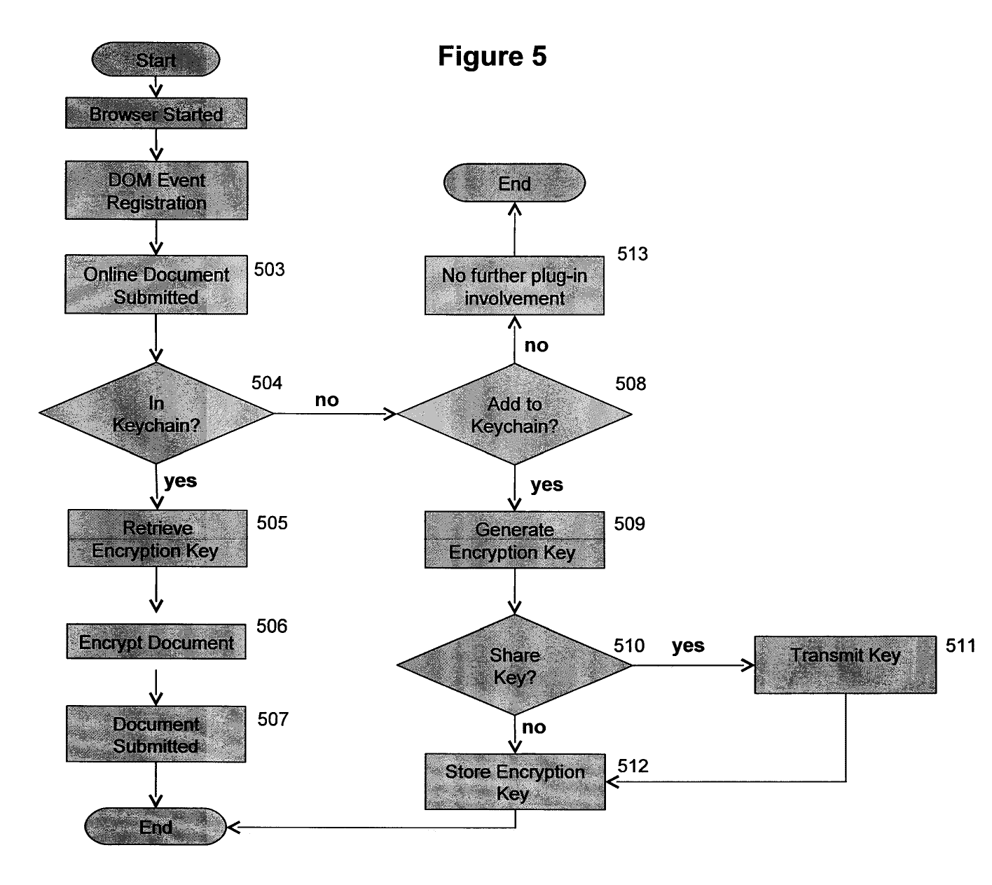

The invention may also be used to encrypt documents prior to storage with a third party where the keychain stores the cryptographic key used to encode and/or decode the documents. The steps involved when the invention is used to submit encrypted documents for storage by a third party will now be described with respect to FIG. 5. Once initialization has been performed, a user may submit (503) a document to a third party that provides an online document storage/retrieval service, such as GoogleDocs®. The plug-in may first check (504) whether a keychain entry exists for the encryption key associated with the submitted document's unique identifier. It will be appreciated that the document may ascribed its unique identifier in a number of different ways, for instance, by way of the unique server website URL corresponding to the document In the event an entry exists, this entry may be copied and decrypted if necessary, thereby retrieving the encryption key for said document. A DOM Event Handler may then encrypt (506) and submit (507) the document to the third party. There are a number of ways that the DOM Event Handler may be triggered. Where a keychain entry does not exist for said document, the user may be prompted (508) as to whether they wish to generate a cryptographic key for the document, encrypt the document, and store the cryptographic key in the keychain. In the event the user chooses to do so, an cryptographic key (or key pair in the event an asynchronous encryption method is to be used) is generated (509), and stored in the keychain (512). After the cryptographic key is generated, the user may also be prompted (510) as to whether they wish to share the cryptographic key with any third parties. If the user chooses to share said cryptographic key, the plug-in may facilitate transmission of the cryptographic key to the designated third party in a variety of ways. In one embodiment, the plug-in may enable the cryptographic key to be sent via the paired wireless device, for example by way of a Short Message Service (SMS) text message. In the event a keychain entry does not exist for the submitted document and the user chooses not to generate a new cryptographic key and add it to the keychain, the plug-in may cease to participate (513) in the document retrieval process.

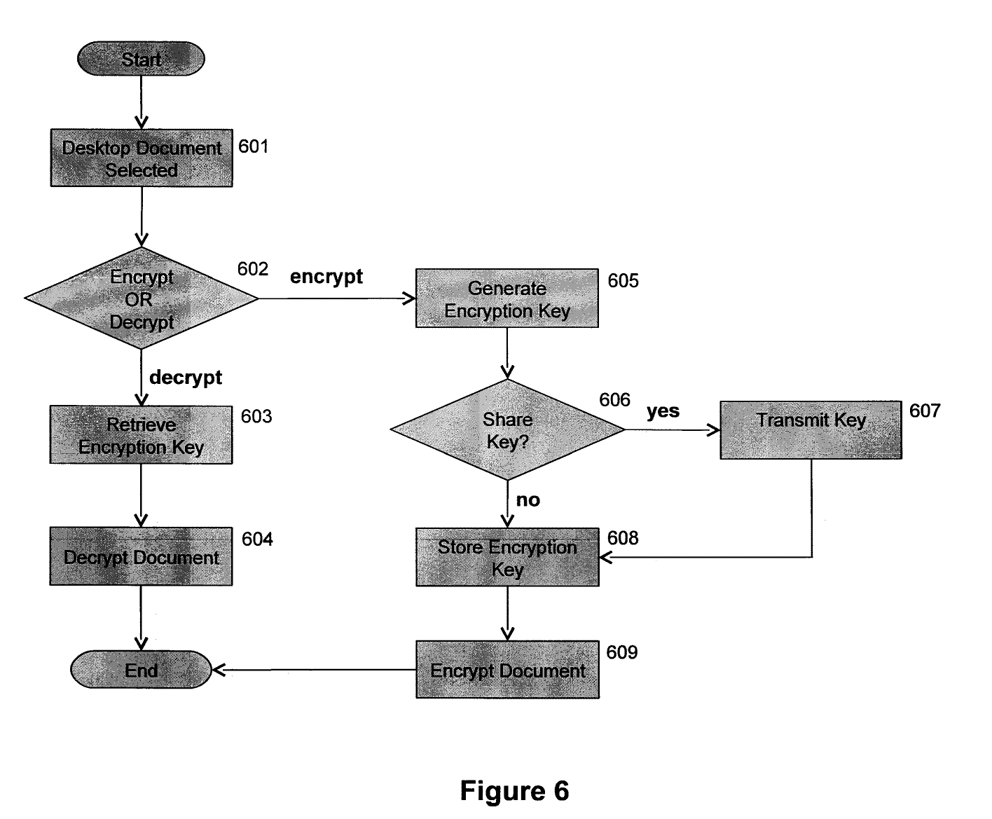

The invention may also be used to enable secure sharing of locally stored documents. This method will now be described with respect to FIG. 6. It will be appreciated that in this embodiment, involvement of an internet browser application may not be necessary. Accordingly, the software associated with the plug-in may also be capable of running as a separate application independently of the browser program. In this embodiment, a user selects (601) a local document and may then choose (602) to perform either an encryption or a decryption operation. These instructions may be given in many ways, for instance by way of modified operating system desktop options, by way of dragging the document to a specialized folder for performing such functions (on operating systems that support such functionality), or even through a menu system in the application itself. In the event a user chooses to encrypt a document, a cryptographic (or cryptographic key pair in the event an asynchronous encryption method is to be used) is first generated (605). The cryptographic key is then stored in the keychain (608) and the document is then encrypted automatically (609). The user may then email or upload the encrypted document to a desired third party. At any point after the cryptographic key is generated, the user may be prompted (606) as to whether they wish to share the cryptographic key with any third parties. If the user chooses to share said cryptographic key, the application or plug-in may facilitate transmission of the cryptographic key to the designated user in a variety of ways. In one embodiment, the application or plug-in may enable the cryptographic key to be sent via the paired wireless device, for example by way of a Short Message Service (SMS) text message.

In the event the user chooses to perform a decryption operation on a local document, the application may seek (603) the keychain entry corresponding to the decryption key for said document. The application then decrypts (604) the document for use by the user. In the event no keychain entry exists for the decryption key for said document, the application may cease to participate in the process (not shown).

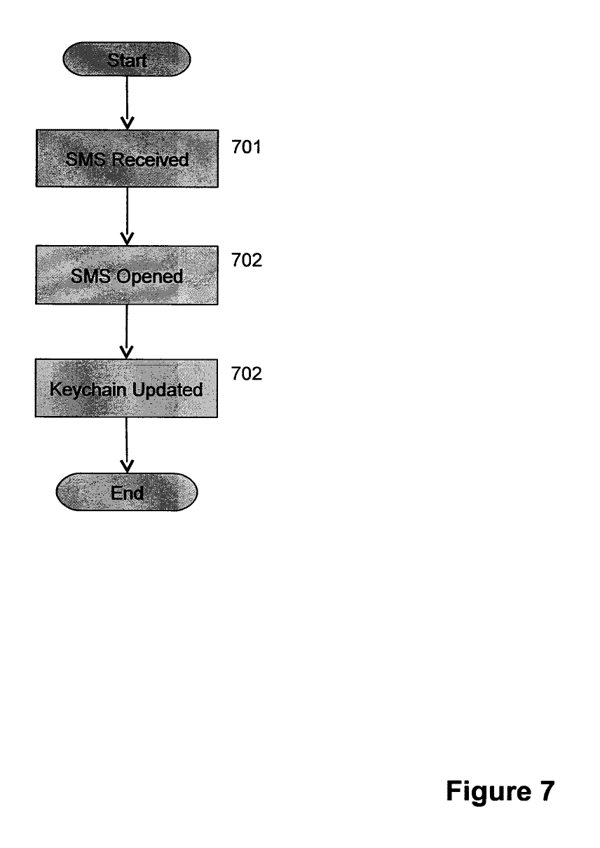

As discussed in FIGS. 5 and 6, certain embodiments of the present invention provide for the sharing of a document cryptographic key. FIG. 7 illustrates how a recipient's keychain may be automatically updated upon receipt of such a shared document cryptographic key, in the event that the key has been sent via SMS text message. It will be appreciated that this cryptographic key may be shared in a variety of other ways, including Bluetooth, WiFi Direct, or push notifications. A recipient receives (701) a SMS text message on their keychain-carrying wireless device and opens (702) said message. It may be then recognized that a document encryption key has been sent, and the user may then add (702) this entry to the keychain on said device. It will be appreciated that adding to the keychain may be done in a variety of ways. For example, if the wireless device is in communication with (and has been initialized with) a browsing computer, then the plug-in may automatically update the keychain. Alternatively, an additional module may be provided for storage on the wireless device, which is capable of taking the contents of the SMS text message and updating the keychain accordingly. Furthermore, it may be possible for the recipient to manually modify the keychain information so as to add the newly-received entry.

It will be appreciated that use of encryption algorithms to secure documents as discussed above in relation to FIGS. 4-7 may entail the use of symmetric or asymmetric cryptographic algorithms. Accordingly, for these embodiments, the encryption and decryption keys may or may not be identical.

By “document” it is meant any electronic file that may be used to present information to an end user. This may include but is not limited to: static and dynamic website file types such as HTML, XHTML, XML, ASPX, PHP and Flash; word processing file types such as DOC, TXT and ODT; spreadsheet file types such as XLS and ODS; document representation file types such as PDF; and presentation file types such as PPT and ODP.

By “Document Object Model (DOM)”, it is meant a platform- and computer language-neutral interface that allows computer programs to dynamically access and update the content, structure and style of documents.

By “DOM Event Handler”, it is meant a computer program or subroutine configured to be responsive to events of specific interest occurring within the framework of the Document Object Model.

By Bluetooth Generic Object Exchange Protocol, it is meant a Bluetooth Profile that defines the protocol requirements necessary for Bluetooth® enabled devices to exchange data.

By File Transfer Protocol (FTP), it is meant a client-sever networking protocol used to facilitate the exchange of files across a network.

By FTP “put” operation, it is meant an FTP subroutine configured to put (or transfer) a specified file to a remote machine.

By FTP “get” operation, it is meant an FTP subroutine configured used to get (or download) a specified file from a remote machine.

By International Mobile Equipment Identity number, it is meant the unique serial number assigned to every mobile device.

The words “comprises/comprising” and the words “having/including” when used herein with reference to the present invention are used to specify the presence of stated features, integers, steps or components but does not preclude the presence or addition of one or more other features, integers, steps, components or groups thereof.

The embodiments in the invention described with reference to the drawings comprise a computer apparatus and/or processes performed in a computer apparatus. However, the invention also extends to computer programs, particularly computer programs stored on or in a carrier adapted to bring the invention into practice. The program may be in the form of source code, object code, or a code intermediate source and object code, such as in partially compiled form or in any other form suitable for use in the implementation of the method according to the invention. The carrier may comprise a storage medium such as ROM, e.g. CD ROM, or magnetic recording medium, e.g. a floppy disk or hard disk. The carrier may be an electrical or optical signal which may be transmitted via an electrical or an optical cable or by radio or other means.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

Although the foregoing described the invention with preferred embodiments, this is not intended to limit the invention. Indeed, the foregoing is intended to cover all modifications and alternative constructions falling within the spirit and scope of the invention as expressed in the appended claims, wherein no portion of the disclosure is intended expressly or implicitly, to be dedicated to the public domain if not set forth in the claims.

1. A method of retrieving data from a wireless device over a wireless network for submission to an application provided on a user terminal, the method comprising the steps of:
detecting for a wireless device when the application is running on the user terminal; and
if a wireless device is detected, in response to an attempt by a user at the user terminal to access a document accessible through the application where data is required to complete a request for access to the document, determining whether the required data exists on a data file stored on the wireless device;
retrieving the required data from the data file and
submitting the retrieved data to the application for generation of an access request.

2. The method of claim 1 wherein the document is one of a website file type, a word processing application file type, a spreadsheet application file type, a document representation application file type, or a presentation application file type.

3. The method of claim 1 wherein the application is an internet browser application.

4. The method of claim 1 wherein the application is an internet browser application having an associated plug-in for performing the steps of the method.

5. The method of claim 1 wherein the application is one of a word processing application, a spreadsheet application, a document representation application, or a presentation application.

6. The method of claim 1 further comprising the steps of:
if the detected wireless device is in communication with the user terminal for the first time, the method further comprising the step of associating the detected wireless device with the user terminal by:
requesting the user to provide the application with identification credentials unique to the wireless device; and
requesting the user to confirm on the wireless device that the wireless device is to communicate with the user terminal.

7. The method of claim 6 further comprising the steps of:
if a plurality of wireless devices are detected, none of which have previously communicated with the user terminal, before requesting the user to associate a wireless device with the user terminal, requesting the user to select the desired wireless device from the plurality of wireless devices to associate with the user terminal.

8. The method of claim 3 wherein the data comprises user authentication credentials for a website.

9. The method of claim 5 wherein the data comprises a cryptographic key.

10. The method of claim 1, further comprising the step of copying the data file from the wireless device to a storage on the user terminal; and wherein the data file from which the required data is retrieved corresponds to the data file stored on the user terminal.

11. The method of claim 1 wherein the wireless communication is via Bluetooth.

12. The method of claim 1 wherein if the required data does not exist on the data file, further comprising the step of requesting the user to submit the required data for the document to the application, and updating the existing data file with the required data.

13. The method of claim 12 wherein the step of updating the existing data file with the required data comprises the steps of updating the stored copy of the data file on the user terminal; and transmitting the updated copy of the data file to the detected wireless device.

14. The method of claim 1 further comprising the step of deleting the stored copy of the data file on the user terminal once the application is no longer running on the user terminal.

15. A method of retrieving data from a wireless device over a wireless network for encrypting or decrypting a document accessible via a document website through a browser application provided on a user terminal, the website adapted to communicate with a document server, the method comprising the steps of:
detecting for a wireless device when the browser application is running on the user terminal; and
if a wireless device is detected, in response to an attempt by a user at the user terminal to access or store a document at the document server through the document website: where data is required to access or store the document;
determining whether the required data exists on a data file stored on the wireless device; retrieving the required data from the data file; and
using the retrieved data to encrypt the document for storage or decrypt the document for access.

16. The method of claim 15 wherein if the required data does not exist on the data file and if it is desired to encrypt the document for storage, further comprising the steps of:
generating the cryptographic key automatically;
encrypting the document using the cryptographic key prior to storage; and
updating the data file with the cryptographic key data.

17. The method of claim 16 further comprising the step of transmitting the cryptographic key to third parties.

18. The method of claim 17 wherein the cryptographic key is transmitted via SMS messaging.

19. An apparatus for retrieving data from a wireless device over a wireless network for submission to an application provided on a user terminal, the apparatus comprising:
logic configured to detect for a wireless device when the application is running on the user terminal; and
if a wireless device is detected, in response to an attempt by a user at the user terminal to access a document accessible through the application where data is required to complete a request for access to the document, logic configured to determine whether the required data exists on a data file stored on the wireless device;
logic configured to retrieve the required data from the data file and
logic configured to submit the retrieved data to the application for generation of an access request.

20. A computer program media embodying a program of instructions executable on a computer to perform a method for retrieving data from a wireless device over a wireless network for submission to an application provided on a user terminal, the method comprising the steps of:
detecting for a wireless device when the application is running on the user terminal; and
if a wireless device is detected, in response to an attempt by a user at the user terminal to access a document accessible through the application where data is required to complete a request for access to the document, determining whether the required data exists on a data file stored on the wireless device;
retrieving the required data from the data file and
submitting the retrieved data to the application for generation of an access request.
